(19) United States
(12) Patent Application Publication
(10) Pub. No.: US 2018/0021995 A1
(43) Pub. Date: Jan. 25, 2018

(54) Method for Producing a Composite Article and Composite Article

(71) Applicant: LEONHARD KURZ Stiftung & Co. KG, furth (DE)

(72) Inventors: Christian Schulz, Furth (DE); Christian Schumacher, Furth (DE); Michael Fuchs, Furth (DE); Martin Hahn, Herrieden (DE)

(21) Appl. No.: 15/541,979

(22) PCT Filed: Jan. 4, 2016
(86) PCT No.: PCT/EP2016/050036

§ 371 Date: Jul. 6, 2017

(30) Foreign Application Priority Data
Jan. 9, 2015 (DE) 10 2015 100 208.6

(51) Int. Cl. B29C 45/14

(52) U.S. Cl. CPC B29C 45/14467; B29C 45/14811; B29C 45/14065

(57) ABSTRACT

A tool mold, which includes a first tool molding part and a second tool molding part, is provided, wherein the first tool molding part and/or the second tool molding part has a filling channel. At least two insertion elements are arranged in such a way that at least one first insertion element of the at least two insertion elements bears at least in some areas against the inner wall of the first tool molding part or against the inner wall of the second tool molding part, and that at least one second insertion element of the at least two insertion elements is arranged at least in some areas on the side of the at least one first insertion element which faces away from the inner wall of the first tool molding part or the side of the at least one first insertion element which faces away from the inner wall of the second tool molding part.

The invention relates to a method for producing a composite article and a composite article.

For the production-integrated surface decoration of plastic parts, plastic films or varnish layers transferable from a carrier film are used. Plastic parts decorated in this way are used, for example, in automobile manufacture for automobile interior parts such as door trims, dash and center console trims, in the consumer electronics sector for decorative trims on television sets or in the telecommunications field for casings for portable devices such as mobile telephones. In the case of the surface decoration of plastic parts, when using IMD technology (IMD=In-Mold Decoration) or IML technology (IML=In-Mold Labeling), a plastic film is inserted into a tool mold and then back injection molded with a filling medium which is initially free-flowing.

The object of the invention is now to indicate an improved production method for a composite article as well as to provide a correspondingly improved composite article.

This object is achieved by a method for producing a composite article with the following steps: a) providing a tool mold which comprises a first tool molding part and a second tool molding part, wherein the first tool molding part and/or the second tool molding part has at least one filling channel; b) arranging at least two insertion elements in such a way that at least one first insertion element of the at least two insertion elements bears at least in some areas against the inner wall of the first tool molding part or against the inner wall of the second tool molding part, and that at least one second insertion element of the at least two insertion elements is arranged at least in some areas on the side of the at least one first insertion element which faces away from the inner wall of the first tool molding part or the side of the at least one first insertion element which faces away from the inner wall of the second tool molding part; c) closing the tool mold by merging the first tool molding part and the second tool molding part; and d) filling a filling medium through the filling channel in such a way that the at least one second insertion element of the at least two insertion elements is pressed against the at least one first insertion element of the at least two insertion elements and that the at least one first insertion element of the at least two insertion elements and the at least one second insertion element of the at least two insertion elements are hereby fixedly connected at least in some areas. This object is furthermore achieved by a composite article, in particular produced according to the method according to one of claims 1 to 21, wherein the composite article comprises a main body made of a filling medium and at least two insertion elements, wherein at least one first insertion element of the at least two insertion elements and at least one second insertion element of the at least two insertion elements are arranged in such a way that the at least one second insertion element of the at least two insertion elements is arranged between the at least one first insertion element of the at least two insertion elements and the main body, and wherein the first insertion element of the at least two insertion elements and the second insertion element of the at least two insertion elements are fixedly connected at least in some areas.

It has hereby been shown that the composite article according to the invention can be produced in one manufacturing step. The composite article is a multilayer composite article which comprises the at least two insertion elements. The insertion elements can have different functionalities. These insertion elements are typically heterogeneous, i.e. they consist of different materials, for example depending on the target function. By means of the method according to the invention it is possible to produce a composite article which has a multilayered, heterogeneous structure, wherein the composite article can be composed of several different materials which, in turn, can be of different sizes and thicknesses. Diverse functionalities can hereby be integrated in the composite article. Furthermore, a durable bond of the heterogeneous structure together with the frequently required accurate registration of these layers with respect to each other, which are ultimately intended to be integrated into a component as a label (in the case of IML) or an insert (in the case of Insert Molding) in the method according to the invention, is hereby achieved. It is thus possible, for example, that an insertion element which is attached to the exterior of the composite article assumes a protective function vis-à-vis environmental influences or mechanical stress on the surface. The insertion element on the exterior thus protects further insertion elements of the composite article which can, for example, contain conductive tracks. It has further been shown that sensitive insertion elements, which have, for example, optically active, in particular optically variable layers, conductive tracks or metalizations, can be encapsulated in a composite article in a single manufacturing step by means of the method according to the invention. On the one hand, the durabilities of multilayer composite articles manufactured in this way can be hereby increased and, on the other hand, the production process is improved in such a way that only one manufacturing step is required for the shaping production of the composite article in a method suitable for short cycle times, such as for example high-pressure injection molding, resin-transfer-molding or low-pressure casting processes. A cost-effective production of complex multilayer composite articles, in particular compared with alternative production methods, is hereby made possible. Thus, in the method according to the invention, compared with known methods such as hot laminating, gluing or plastics welding, it is possible, for example, to achieve the connection to each other of an injection-molded part made of thermoplastic with precisely positioned conductive track layers on a carrier material different from the filling medium and with a further protective layer which differs from the size of the conductive track layer and is made of a plastic material which in turn is different at high optical quality in a single simultaneously molding, shaping and joining manufacturing step. Known methods each have considerable limitations in this respect. Thus, lamination methods are restricted predominantly to two-dimensional geometries with respect to the possible component shape. Where the layers to be connected have different dimensions, lamination e.g. in a plate laminator leads to impairment of the optical surface quality. Plastics welding methods are not suitable for the connection of larger components over the whole surface. Gluing methods require the accurate application of liquid glue systems and a separate application of the individual layers to a plastic semifinished part to be manufactured in advance. Where the layers to be connected have different dimensions, during gluing and caused by the different thicknesses applied to the plastic semifinished part, visible increments are to be expected on the surface, which ultimately mean an impairment of the optical quality. In addition to the advantages already mentioned, the method according to the invention enables a variable design of the layer structure of the composite article. Thus, for example, the second insertion element of the at least two insertion elements can be applied in some areas such that this second insertion element of the at least two insertion elements is completely encapsulated by the first insertion element of the at least two insertion elements and the filling medium.

By the term “fixedly connected” is here meant a durable connection of two elements with the result that they no longer separate from each other when the composite article is used as intended. Thus, for example, the at least one first insertion element of the at least two insertion elements and the at least one second insertion element of the at least two insertion elements are fixedly connected when a mechanically durable connection exists between these two insertion elements and the at least one first insertion element of the at least two insertion elements and/or the at least one second insertion element of the at least two insertion elements cannot be separated from each other without damage.

By the term “area” is here meant a defined zone which is occupied by an insertion element or a layer of an insertion element, wherein the zone lies in a surface formed by the inner wall of a tool molding part. Thus, for example, the at least one first insertion element, which is arranged on the inner wall of the first tool molding part or on the inner wall of the second tool molding part, forms an area which occupies a defined zone.

By the term “filling medium” is meant a substance, mixture of substances or sequence of filled media which is/are capable, through filling into the tool, of bringing about the connection between the at least two insertion elements by introducing a significant part of the energy required therefor. The filling medium can consist of a thermoplastic, a thermosetting reaction resin system, an elastomer, the respective educts thereof, initiators or a mixture of the same and, at the same time, also undergo an adhesive connection to one or more of the at least two insertion elements. It is thus possible that the filling medium is an injection molding compound which is injected into the tool.

Furthermore, it is possible for the tool mold to have further tool molding parts. Thus, in addition to the first tool molding part and the second tool molding part, the tool mold can, for example, comprise a third tool molding part. It is thus possible for the tool mold to comprise two or more tool molding parts. The tool mold is preferably an injection mold and the first tool molding part a first injection molding part and the second tool molding part a second injection molding part, wherein the first injection molding part and/or the second injection molding part has at least one injection channel.

Further advantageous embodiments of the invention are described in the dependent claims.

It has proved useful that, in step d), the at least one first insertion element of the at least two insertion elements and/or the at least one second insertion element of the at least two insertion elements are fixedly connected at least in some areas to the filling medium.

Preferably, in step b), the at least one first insertion element of the at least two insertion elements and the at least one second insertion element of the at least two insertion elements are arranged accurately fitting with respect to each other. The accurately fitting arrangement with respect to each other can also take place in a previous step. Possibilities for the accurately fitting arrangement of the at least two insertion elements with respect to each other are described below.

By accurately fitting or in register is meant the relative positionally accurate position of second insertion elements with respect to each other. The positionally accurate position can be effected by means of visually detectable registration marks or register marks on the tool molding parts and/or on the insertion elements or through structural features such as, for example, studs, pins, recesses etc. on the tool molding parts and/or on the insertion elements. The positionally accurate position of the insertion elements relative to each other and/or the positionally accurate position of the insertion elements relative to the tool molding parts can thereby be set.

Advantageously, in step b), the at least one first insertion element of the at least two insertion elements and the at least one second insertion element of the at least two insertion elements are not connected. The at least two insertion elements can hereby be arranged in the tool mold flexibly and as individually required independently of each other.

The at least two insertion elements, in particular the at least one first insertion element of the at least two insertion elements and the at least one second insertion element of the at least two insertion elements, are preferably arranged accurately fitting each other by means of a vacuum, a clamping system or an advancing system and held in the tool mold.

It is also possible that a tool mold is provided with lugs, pins or shaped recesses in the first tool molding part and/or in the second tool molding part and that the at least two insertion elements, in particular the at least one first insertion element of the at least two insertion elements and the at least one second insertion element of the at least two insertion elements, are arranged accurately fitting each other and also held in the first tool molding part and/or in the second tool molding part by means of the lugs, pins or shaped recesses.

Furthermore, it is possible that the at least two insertion elements, in particular the at least one first insertion element of the at least two insertion elements and the at least one second insertion element of the at least two insertion elements, are held by means of a pressure-sensitive adhesive and/or by means of electrostatic or physical adhesion and are arranged accurately fitting each other. Pressure-sensitive adhesives are adhesives which allow two elements to adhere to each other in dependence on the force exerted on the adhesive surface. Here, the adhesion is first of all such that the at least two insertion elements have at least the adhesion to each other required for the method but, as a rule, not yet the adhesive force with respect to each other necessary for the intended application. It can also be provided that the adhesion between two or more of the at least two insertion elements is only temporary and a separation is possible after the method, in which at least one of the at least two insertion elements separated from each other remains undamaged.

It is hereby achieved that the at least two insertion elements are arranged accurately fitting each other before the filling of the filling medium and can no longer move substantially with respect to each other before the filling with the result that the accurately fitting arrangement required for the respective application is ensured.

Furthermore, it is possible that the at least one first insertion element of the at least two insertion elements and the at least one second insertion element of the at least two insertion elements are arranged in the tool mold at the same time. Such a simultaneous arrangement of the at least two insertion elements can be achieved, for example, through a pressure-sensitive adhesive and/or electrostatic or physical adhesion. The at least two insertion elements adhere to each other here such that they can be arranged or introduced simultaneously. Here, the adhesion is such that the at least two insertion elements have at least the adhesion to each other required for the method but, as a rule, not yet the adhesive force with respect to each other necessary for the intended application. Here, the adhesion is set in particular such that the at least two film elements can be separated again without damaging them.

Furthermore, it is advantageous that the at least one first insertion element of the at least two insertion elements and the at least one second insertion element of the at least two insertion elements are positioned registered or accurately fitting on the inner wall of the first tool molding part or on the inner wall of the second tool molding part.

It is also possible that the at least one first insertion element of the at least two insertion elements and/or the at least one second insertion element of the at least two insertion elements is folded such that the at least one first insertion element of the at least two insertion elements and/or the at least one second insertion element of the at least two insertion elements forms a stack of two or more rows in a direction substantially perpendicular to a surface formed by a side of the inner wall of the first tool molding part or to a surface formed by a side of the inner wall of the second tool molding part. It is hereby possible, for example, that the at least one first insertion element and/or the at least one second insertion element form a system which is folded at least once.

Furthermore, it is possible that the at least one first insertion element of the at least two insertion elements and/or the at least one second insertion element of the at least two insertion elements is folded such that the at least one first insertion element of the at least two insertion elements and the at least one second insertion element of the at least two insertion elements form a stack of n>2 rows in a direction substantially perpendicular to a surface formed by a side of the inner wall of the first tool molding part or to a surface formed by a side of the inner wall of the second tool molding part, wherein the rows of the n>2 rows consist alternately of the at least one first insertion element of the at least two insertion elements and the at least one second insertion element of the at least two insertion elements. It is hereby possible, for example, that the at least one first insertion element and the at least one second insertion element form a folded system such that, for example, the at least one first insertion element of the at least two insertion elements is folded and forms a first and a third row of the stack and the at least one second insertion element of the at least two insertion elements is arranged between the first and third rows of the stack in the second row of the stack.

In a further advantageous embodiment variant, in step a), a tool mold is provided with at least one cavity outlet in the first tool molding part and/or in the second tool molding part and, in step b), the at least one first insertion element of the at least two insertion elements and/or the at least one second insertion element of the at least two insertion elements is arranged such that the at least one cavity outlet is sealed, after merging of the first tool molding part and the second tool molding part, by the at least one first insertion element of the at least two insertion elements and/or the at least one second insertion element of the at least two insertion elements. This sealing is effected in particular by mechanical loading of the sealing insertion elements by the adjacent tool molding parts lying or pressing on them. It is hereby possible to guide the at least one first insertion element of the at least two insertion elements and/or the at least one second insertion element of the at least two insertion elements out of the tool mold. These outlets can be used, for example, to guide out electrical contacts, an inserted semifinished part or to couple light into a light guiding structure.

Furthermore, it is advantageous if, in step a), a tool mold is provided with at least one shaped recess in the first tool molding part and/or in the second tool molding part and, in step b), the at least one first insertion element of the at least two insertion elements is inserted into the at least one shaped recess such that the at least one first insertion element of the at least two insertion elements forms a planar surface with the internal wall of the first tool molding part and/or the internal wall of the second tool molding part. A composite article can hereby be produced which, in the area formed by the at least one first insertion element of the at least two insertion elements, has a non-planar surface. It is furthermore possible hereby that the at least one second insertion element of the at least two insertion elements is exposed at least in some areas on the upper partial surface of the multilayer composite article and is thus directly accessible.

According to a further embodiment example of the invention, the at least one first insertion element of the at least two insertion elements arranged in step b) has a structural layer and/or a structured surface profile and, in step d), the filling medium is filled in such a way that the structural layer and/or a structured surface profile stamps a relief on the at least one second insertion element of the at least two insertion elements. It is hereby possible, for example, also to stamp a surface profile of the at least one first insertion element on the previously unstructured at least one second insertion element. On the one hand this reduces the production costs since the at least one second insertion element does not need to be correspondingly prestamped and, on the other hand, a very precise imprinting of the surface structure within the multilayer composite article is achieved. Waste can also be further reduced hereby since fewer process steps are required, in which in each case waste can arise, for example, through imprecise embossing of an insertion element. If such a multilayer composite article were to be produced using individual process steps by means of conventional methods, such as for example embossing techniques, further process steps would thus be necessary. In contrast, in the method according to the invention, for example, a working step with respect to the provision of embossing tools and, for example, a working step with respect to the exact merging of the insertion elements after the embossing are dispensed with. It is thus possible to produce multilayer composite articles with three-dimensional surface structures in at least two insertion elements simply and cost-effectively with the method according to the invention. In this highly flexible process it is additionally possible to change the introduced structure at any time without adapting the tool molding parts; it is only necessary for one insertion element of the at least two insertion elements to be used with a corresponding structural layer.

According to a further preferred embodiment example, the at least one first insertion element of the at least two insertion elements and/or the at least one second insertion element of the at least two insertion elements has a structural layer and/or a structured surface profile.

It is possible that the structural layer is produced from a material curable by means of electromagnetic radiation and/or thermally. The structural layer can be produced from a structured varnish which cures, dries or crosslinks thermally or by means of electromagnetic radiation. Furthermore, it is possible that the structural layer consists of a replication varnish layer, for example of a thermoplastic varnish into which a surface profile is molded by means of heat and pressure by the action of an embossing tool. Furthermore, it is also possible that the replication varnish layer is formed by a UV-crosslinkable varnish and that the surface profile is molded into the replication varnish layer by means of UV replication. The surface profile is molded onto the uncured replication varnish layer by the action of an embossing tool and the replication varnish layer is cured by irradiation with UV light immediately during or after the molding.

The structural layer preferably has a thickness between 2.5 μm and 1500 μm, preferably between 10 μm and 200 μm, further preferably between 15 μm and 65 μm.

It is possible that the structural layer has areas which can be deformed more or less under pressure and heat than the rest of the structural layer, wherein the areas have a height, based on a direction substantially perpendicular to a surface formed by a side of the inner wall of the first tool molding part or to a surface formed by a side of the inner wall of the second tool molding part, in particular between 2.5 μm and 1500 μm, preferably between 10 μm and 200 μm, further preferably between 15 μm and 65 μm.

Furthermore, it is possible that the structure depth of the structured surface profile is between 2.5 μm and 1500 μm, preferably between 10 μm and 200 μm, further preferably between 15 μm and 65 μm.

It is possible that, in step b), the at least one first insertion element of the at least two insertion elements is arranged such that the at least one first insertion element of the at least two insertion elements occupies the internal wall of the first tool molding part and/or the internal wall of the second tool molding part in a first area and does not occupy it in a second area, and that the at least one second insertion element of the at least two insertion elements occupies at least the second area. It is hereby possible, for example, that the at least one first insertion element of the at least two insertion elements and the at least one second insertion element of the at least two insertion elements are exposed at least in some areas on the surface of the composite article and are thus directly accessible.

Furthermore, it is advantageous that the at least one second insertion element of the at least two insertion elements is arranged on the side of the at least one first insertion element which faces away from the internal wall of the first tool molding part and/or the side of the at least one first insertion element which faces away from the internal wall of the second tool molding part such that the at least one first insertion element of the at least two insertion elements is covered at least in some areas in the first area by the at least one second insertion element of the at least two insertion elements. It is hereby possible that the at least one second insertion element of the at least two insertion elements adapts to the shape of the at least one first insertion element of the at least two insertion elements. Composite articles produced in this way are particularly advantageous when they have contacts or sensors which are intended to be reachable from the outside. Furthermore, composite articles produced in this way can have particular decorative three-dimensional surface effects.

The parameters pressure and temperature are preferably chosen in step d) during filling of the filling medium such that the at least two insertion elements, in particular the at least one first insertion element of the at least two insertion elements and/or the at least one second insertion element of the at least two insertion elements, are fixedly connected at least in some areas to each other and/or the filling medium. A further embodiment of the tool molding parts can additionally include that the optimum temperature progression for the method for producing a composite article is supported by a variothermal temperature control that is already integrated in the tool molding parts.

Furthermore, it is advantageous that the optimum temperature progression for the method is supported by a variable tempering of the tool mold.

Furthermore, it is possible that the parameter time, which results predominantly from material properties, temperature ratios and mass ratios of the introduced insertion elements and filling media as well as the tool temperature, is additionally influenced by a variable temperature control of the tool. In correlation with these parameters, the parameter time in step d) during filling of the filling medium can be chosen such that the at least two insertion elements, in particular the at least one first insertion element of the at least two insertion elements and/or the at least one second insertion element of the at least two insertion elements, are fixedly connected at least in some areas to each other and/or the filling medium.

Depending on the material used for the at least two insertion elements and for adhesion promoters used to connect the at least two insertion elements and applied in each case to at least one of the sides of the at least two insertion elements facing each other at least in some areas, the parameters time, pressure and temperature can be adapted such that the at least two insertion elements fixedly connect at least in some areas to each other and/or to the filling medium. When using reaction adhesives as adhesion promoter, it is preferred to post-temper the composite article produced using the method again subsequently. The adhesion of the at least two insertion elements to each other and/or to the filling medium is hereby further increased.

In step d), the filling of the filling medium preferably takes place at a temperature in the range between 200° C. and 320° C., preferably between 240° C. and 290° C., further preferably between 240° C. and 270° C., and/or, in step c), the filling of the filling medium preferably takes place at a temperature of the tool mold in the range between 30° C. and 120° C., preferably between 40° C. and 100° C., further preferably between 60° C. and 80° C.

In step d), the filling of the filling medium advantageously takes place at a pressure in the range between 10 bar and 2000 bar, preferably between 200 bar and 1500 bar, further preferably between 500 bar and 1300 bar.

According to a further preferred embodiment example, instead of a curing substance or substance mixture, the filling medium can consist of a gas or a liquid brought into the gas phase, which is appropriately heated by pre-heating or compression. In this case, only the connection between the at least two insertion elements is then produced, without a further connection to a filling medium forming.

It is possible, in step b), that the at least one first insertion element of the at least two insertion elements and the at least one second insertion element of the at least two insertion elements consist of different materials. It is thus possible, for example, that the at least one first insertion element of the at least two insertion elements or the at least one second insertion element of the at least two insertion elements consist of thermoplastic PET (=polyethylene terephthalate), PP (=polypropylene), ABS (=acrylonitrile-butadiene-styrene), PC (=polycarbonate), PVC (=polyvinyl chloride), PEN (=polyethylene naphthalate) or PA (=polyamide), or a TPE (=thermoplastic elastomer) or the thermosetting synthetic resins PUR (=polyurethane), EP (=epoxy), PF (=phenolic) or UP (=unsaturated polyester) resins. Furthermore, it is possible that the at least two insertion elements are multilayered and layers which are adjacent to each other, in particular of the at least one first insertion element of the at least two insertion elements or of the at least one second insertion element of the at least two insertion elements, consist of different materials.

It has proved useful if the filling medium and the layers adjacent to the filling medium of the at least two insertion elements, in particular of the at least one first insertion element of the at least two insertion elements and/or of the at least one second insertion element of the at least two insertion elements and/or of at least one third insertion element in the case of three or more insertion elements, are selected from the group of the following material pairs PP and PP, ABS and ABS/PC, PC and PC, PC and ABS/PC, ABS and PBT (=polybutylene terephthalate) or ABS and PMMA (=polymethyl methacrylate), wherein the first named material corresponds to the material of the layer adjacent to the filling medium and the material or material mixture named in second place corresponds to the material of the filling medium. It has been shown that material pairs of this type enable fixed connections within the meaning of the invention. Furthermore, material pairs of this type are also suitable for the at least two insertion elements. It is also possible that adjacent layers of the at least two insertion elements consist of the same material, such as for example PET, PP, ABS, or polyamide or a material mixture such as PET and PC. Adjacent layers of the at least two insertion elements can also consist of different materials or material mixtures. Furthermore, it has proved advantageous, in the case of material pairs which do not intrinsically form a fixed connection to each other within the meaning of the invention, to resort to adhesive or adhesion promoter layers or a thermal, physical or chemical pretreatment which, when using the method, enable a fixed connection within the meaning of the invention. These coatings and or pretreatments are preferably effected on the at least one first insertion element of the at least two insertion elements and/or the at least one second insertion element of the at least two insertion elements and are chosen such that a fixed connections within the meaning of the invention can be produced at least in some areas. In particular, thermal and physical pretreatments preferably take place immediately before the arrangement of the at least two insertion elements in the tool or in the tool itself.

The thicknesses of the at least two insertion elements, in particular of the at least one first insertion element of the at least two insertion elements and/or of the at least one second insertion element of the at least two insertion elements, are advantageously at least 4 μm, preferably between 36 μm and 5 mm, further preferably between 50 μm and 3 mm, and yet further preferably between 50 μm and 1 mm. Furthermore, it is advantageous if the insertion elements arranged between filling medium and the at least one first insertion element of the at least two insertion elements, in particular the at least one second insertion element of the at least two insertion elements, are thinner than the first insertion element. An efficient transfer of heat through the insertion elements arranged between filling medium and the at least one first insertion element of the at least two insertion elements to the at least one first insertion element of the at least two insertion elements is hereby enabled.

Furthermore, it is possible that one or more surfaces of one or more materials introduced into the composite article and/or the one or more of the at least two insertion elements are completely or partially preprocessed by thermal, physical or chemical surface treatment.

It is also possible that the filling medium filled in step d) is supplemented or replaced by a preheated semifinished part.

The filling medium is preferably a polymeric material, for example PP, PC, ABS, PBT (=polybutylene terephthalate), PMMA (=polymethyl methacrylate), PS (=polystyrene), PVC, TPU (=thermoplastic elastomer based on urethane), polyamide or polyolefin, or thermosetting reaction resin systems, in particular PUR, EP resins, PF resins or UP resins. Furthermore, it is advantageous, in particular in the case of functional integrations in the composite article, if the filling medium is blends or mixtures of different types of material, and/or the filling medium is already enriched with reinforcing agents, such as for example glass, carbon or natural fibers, which, in turn, can be present as short or long fibers, and/or fillers, such as for example copper, aluminum oxide or graphite, and/or additives, as serve for example for coloring, laser marking, varnishing, foam formation, dissipation of static charge or the formation of electrical conductivity paths.

The thickness of the filling medium is preferably 0.1 mm to 5 mm, preferably 0.5 mm to 2 mm.

Furthermore, it is advantageous that the at least one first insertion element of the at least two insertion elements and/or the at least one second insertion element of the at least two insertion elements has an adhesive layer. The adhesive layer can, for example, be formed as a layer made of PVC (=polyvinyl chloride) with a thickness between 0.4 μm and 8 μm, preferably between 0.6 μm and 2 μm.

It is advantageous that, in step b), the at least one first insertion element of the at least two insertion elements is arranged with at least one adhesive layer and/or the at least one second insertion element of the at least two insertion elements is arranged with at least one adhesive layer, wherein the parameters pressure and temperature in step d) during filling of the filling medium are chosen such that the at least one adhesive layer is fixedly connected at least in some areas to the at least one second insertion element of the at least two insertion elements and/or the at least one first insertion element of the at least two insertion elements. It is hereby achieved that the at least one first insertion element of the at least two insertion elements is fixedly connected to at least one adhesive layer and/or the at least one second insertion element of the at least two insertion elements and/or the filling medium are fixedly connected at least in some areas. This is advantageous in particular if the composite article to be produced has insertion elements which comprise inorganic materials, such as for example ceramics, glass or metals. This is also advantageous, for example, if layers of different types, for example of the at least one second insertion element of the at least two insertion elements and of the filling medium, are adjacent to each other, such as for example PET and polyamide or polyamide and polyolefin.

Furthermore, it is possible that, in step b), the at least one second insertion element of the at least two insertion elements is provided with a first adhesive layer on the side of the at least one second insertion element of the at least two insertion elements which faces the inner wall of the first tool molding part or the side of the at least one second insertion element of the at least two insertion elements which faces the inner wall of the second tool molding part and that the at least one second insertion element of the at least two insertion elements is provided with a second adhesive layer on the side of the at least one second insertion element of the at least two insertion elements which faces away from the inner wall of the first tool molding part or the side of the at least one second insertion element of the at least two insertion elements which faces away from the inner wall of the second tool molding part, wherein the parameters pressure and temperature in step d) during filling of the filling medium are chosen such that the first adhesive layer and the at least one first insertion element of the at least two insertion elements are fixedly connected at least in some areas and the second adhesive layer are fixedly connected to the filling medium at least in some areas.

It is thus possible that the at least one adhesive layer is arranged on the side of the at least one first insertion element of the at least two insertion elements which faces the second insertion element of the at least two insertion elements.

Furthermore, it has proved useful if a first adhesive layer is arranged on the side of the at least one second insertion element of the at least two insertion elements which faces the first insertion element of the at least two insertion elements and if a second adhesive layer is arranged on the side of the at least one second insertion element of the at least two insertion elements which faces the main body.

According to a further embodiment example of the invention, in step b), the at least one first insertion element of the at least two insertion elements is arranged in one or more third areas and is not arranged in one or more fourth areas, wherein the internal wall of the first tool molding part and/or the internal wall of the second tool molding part of the tool mold provided in step a) has, in the one or more fourth areas, an elevation and, in the one or more third areas, does not have the elevation. It is hereby possible that particular areas on the surface of the composite article to be produced are recessed such that the multilayer composite article does not have the at least one first insertion element of the at least two insertion elements in these areas. Elevations of this type also serve for the accurately fitting arrangement or the registered positioning of the at least one first insertion element of the at least two insertion elements. The elevations can, for example, be pins or studs. Furthermore, it is also possible that the at least one second insertion element of the at least two insertion elements is arranged in the one or more third areas and is not arranged in the one or more fourth areas.

Advantageously, the method comprises the following further steps, which are performed after step d): e) curing the filling medium to form a main body; and f) removing the cured main body including the at least two insertion elements arranged thereon, wherein the main body and the at least one first insertion element of the at least two insertion elements fixedly connected thereto at least in some areas and/or the at least one second insertion element of the at least two insertion elements, which is fixedly connected at least in some areas to the first insertion element of the at least two insertion elements, provide the composite article.

Within the meaning of the present invention, the filling medium is referred to as cured when its hardness and/or resistance has a defined minimum value. The defined minimum value here depends on the subsequent processing steps or the final intended use of the composite article, thus, for example, the defined minimum value for the use of a composite article in an automobile differs from the use of a composite article in a television set, since composite articles in the automotive sector are exposed, for example, to environmental influences and stronger mechanical loads.

It is possible that, in step e), during curing of the filling medium, in the one or more fourth areas in the filling medium, one or more spatial recesses are formed, which correspond to the negative form of the elevation in the one or more fourth areas. It is hereby possible, for example, to make insertion elements which lie inside the multilayer composite article to be produced accessible via the spatial recesses. Thus, for example, the at least one second insertion element of the at least two insertion elements can be reached through the recesses of the cured filling medium.

Furthermore, it is possible that the composite article removed in step f), which comprises the cured main body including the at least two insertion elements arranged thereon, is post-tempered and/or that, after or during curing of the filling medium to form a main body, the composite article, which comprises the cured main body including the at least two insertion elements arranged thereon, is post-tempered in the tool mold in step e).

It is advantageous that, in step b), three or more insertion elements are provided in such a way that at least one third insertion element of the three or more insertion elements is arranged at least in some areas on the side of the first insertion element of the at least two insertion elements which faces away from the inner wall of the first tool molding part or the side of the first insertion element of the at least two insertion elements which faces away from the inner wall of the second tool molding part. A composite article according to the invention, which comprises at least three insertion elements, can hereby be manufactured in a single process step. The production costs can hereby be further reduced. Depending on the thickness of the three or more insertion elements, it is possible, for example, to generate depth effects and/or movement effects. Thus, for example, the first and the third insertion element can have a decorative layer such that an observer of the multilayer composite article according to the invention perceives a Moire effect. Here, the second insertion element can be designed transparent, for example, and serves as spacer for the first insertion element and the third insertion element.

Furthermore, it is advantageous that the at least one third insertion element of the three or more insertion elements is arranged next to the at least one second insertion element of the at least two insertion elements.

Furthermore, it is possible that, in step d), the at least one first insertion element of the at least two insertion elements and the at least one third insertion element of the three or more insertion elements are fixedly connected by the filling of the filling medium and/or the at least one second insertion element of the at least two insertion elements and the at least one third insertion element of the three or more insertion elements are fixedly connected by the filling of the filling medium.

Advantageously, in step d), the at least one third insertion element of the three or more insertion elements is fixedly connected at least in some areas to the filling medium.

Furthermore, it is advantageous if the at least one first insertion element of the at least two insertion elements is a transfer film. The transfer film can comprise a carrier film, a detachment layer and a transfer ply. Thus, after the removal of the cured main body including the at least two insertion elements arranged thereon, wherein the transfer ply represents the first insertion element, the carrier film can be removed with the result that the transfer ply from the transfer film remains on the composite article. It is hereby possible that conventional in-mold decoration (IMD) films can be used as first insertion element of the at least two insertion elements.

According to a further embodiment example of the invention, the at least one first insertion element of the at least two insertion elements and/or the at least one second insertion element of the at least two insertion elements comprises a carrier layer. It has proved useful if the carrier layer is, for example, a polyester film.

Furthermore, the carrier layer can be made of ABS, PEN, PC, PVC, PBT, PMMA or PET. The carrier layer preferably has a thickness between 4 μm and 75 μm, preferably between 15 μm and 50 μm.

It is possible for the carrier layer to be a dyed carrier layer.

Furthermore, it is possible for the carrier layer to be a carrier layer enriched with reinforcing agents and/or fillers and/or additives.

Furthermore, it is possible that a surface profile is molded into the carrier layer by the action of a tool. In particular, a surface structure can be introduced into the surface of the carrier layer for example by stamping or scratching.

According to a further embodiment example of the invention, the at least one first insertion element of the at least two insertion elements and/or the at least one second insertion element of the at least two insertion elements has at least one functional layer. Such a functional layer is preferably formed from one or more of the following layers: a layer containing register marks, a layer containing a marking that can be detected haptically or by tactile means, an electrical functional layer, for example electrically conductive or semiconductive layer. The electrically conductive layer can comprise electrical conductive tracks made of metal and/or conductive polymers, electronic components, optoelectronic components or photosensitive components, for example. Furthermore, the functional layer can comprise, for example, an electrical oscillating circuit, an antenna, a sensor element or sensor field, for example a capacitive or resistive touch sensor field, a sensor for gesture control, an electrical display device or an electrical circuit with conductive tracks or electrical components. Furthermore, the functional layer can comprise optical components, such as for example LEDs, OLEDs or optical waveguides. The functional layer preferably has a thickness between 0.02 μm and 2 mm, further preferably between 3 μm and 1 mm.

The at least one functional layer is preferably an optically active layer and/or has metalized areas, in particular conductive tracks.

Advantageously, the at least one first insertion element of the at least two insertion elements and/or the at least one second insertion element of the at least two insertion elements has at least one decorative layer. The decorative layer can comprise decorative layers, such as e.g. opaque, translucent or transparent colored varnish layers, replication varnish layers or metal layers. The decorative layers can be molded for example over the whole surface or patterned, for example in the shape of alphanumeric characters or motifs. Furthermore, the decorative layer can comprise optically variable layers, e.g. with pigments, holograms, optical diffraction structures, lenses, prisms, thin film layers or crosslinked liquid crystals. Thus, the decorative layer can comprise at least one layer with a decorative effect and/or a forgery-proofing function.

Furthermore, it is possible for the decorative layer to comprise a protective layer. A protective layer can be a transparent or translucent or opaque varnish layer with or without coloration, which is preferably resistant to external physical, in particular mechanical and/or chemical influences.

It has proved useful if the decorative layer has a thickness of more than 0.1 μm, preferably has a thickness between 0.2 μm and 10 μm, further preferably between 0.25 μm and 5 μm.

Furthermore, it is advantageous if the at least one first insertion element of the at least two insertion elements and/or the at least one second insertion element of the at least two insertion elements has at least one separation layer at least in some areas. It is hereby possible that areas which have the separation layer can be detached and are thus accessible, for example. Thus, for example, the at least one first insertion element of the at least two insertion elements can be detached in these areas from the at least one second insertion element of the at least two insertion elements and thus the at least one second insertion element of the at least two insertion elements can be accessible for electrical contacts. Because of a low adhesive force, the separation layer hereby enables the detachment in the areas which have the separation layer. As examples of the separation layer, layers made of cellulose buturate, acrylates, nitrocellulose, ethyl acetate, butyl acetate or styrene copolymer are to be named. The separation layer preferably has a thickness between0.2 μm and 4 μm, preferably 0.5 μm and 2.5 μm, further preferably 0.8 μm and 2.0 μm.

Embodiment examples of the invention are explained by way of example in the following with the aid of the attached figures, which are not to scale.

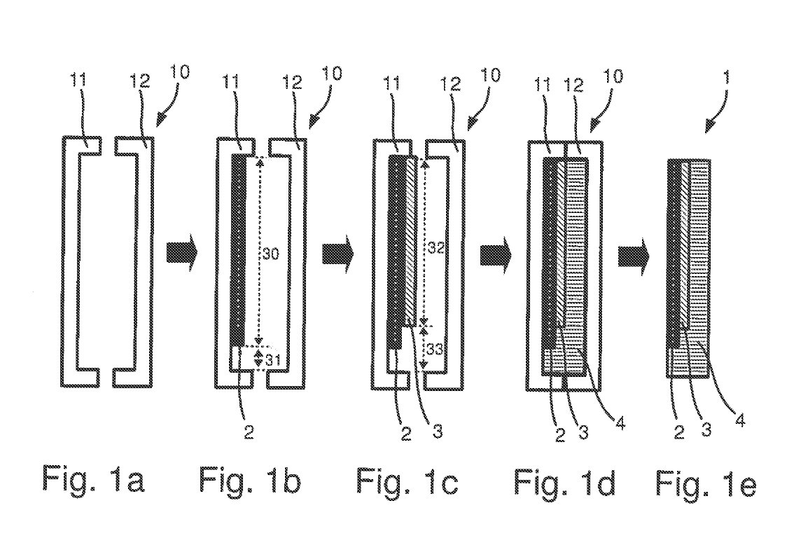

FIG. 1a to FIG. 1e show schematically method steps for producing a composite article

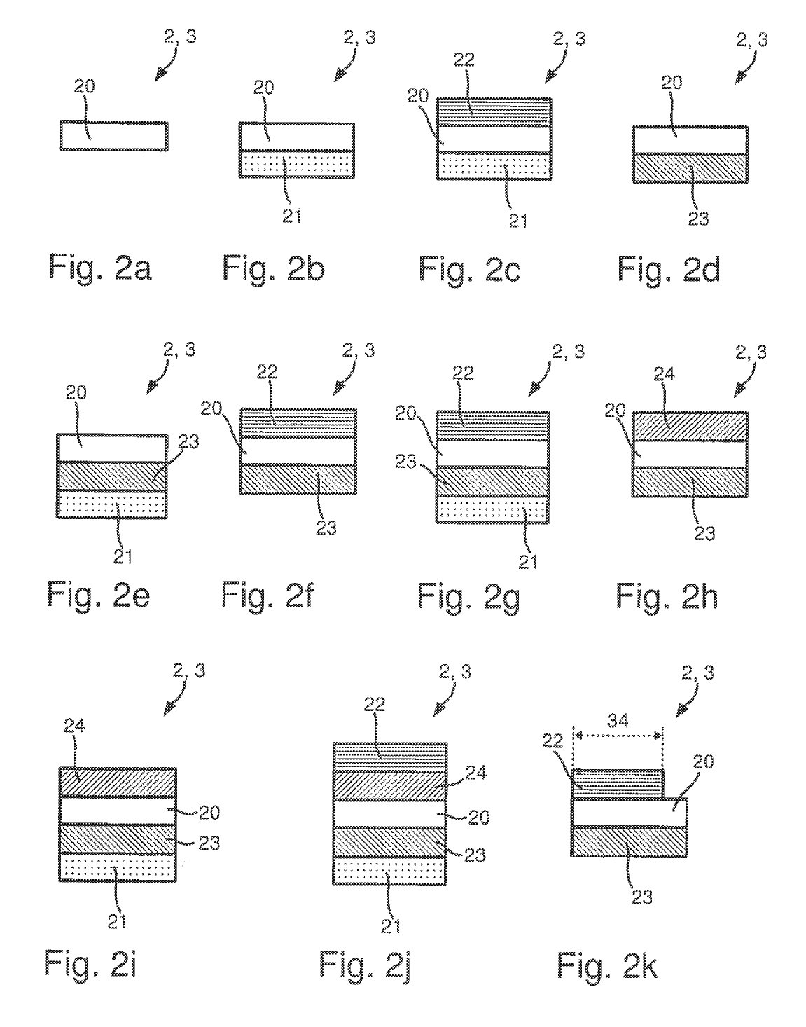

FIG. 2a to FIG. 2k show schematic sectional representations of insertion elements

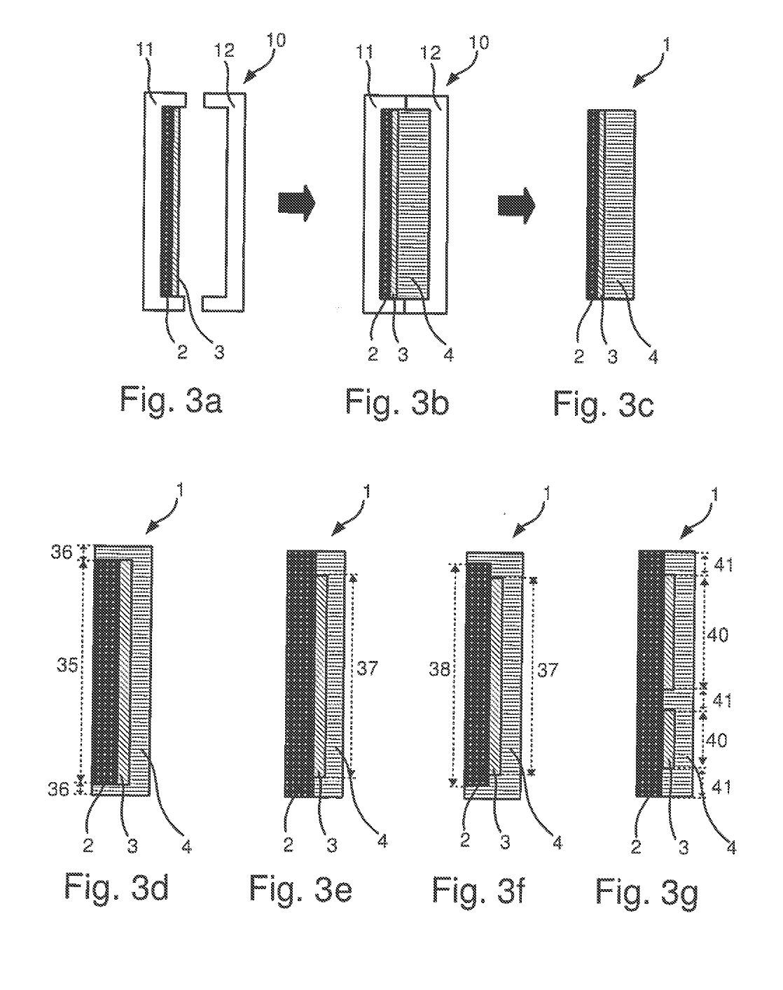

FIG. 3a to FIG. 3c show schematically method steps for producing a composite article

FIG. 3d to FIG. 3g show schematic sectional representations of design variants of a composite article

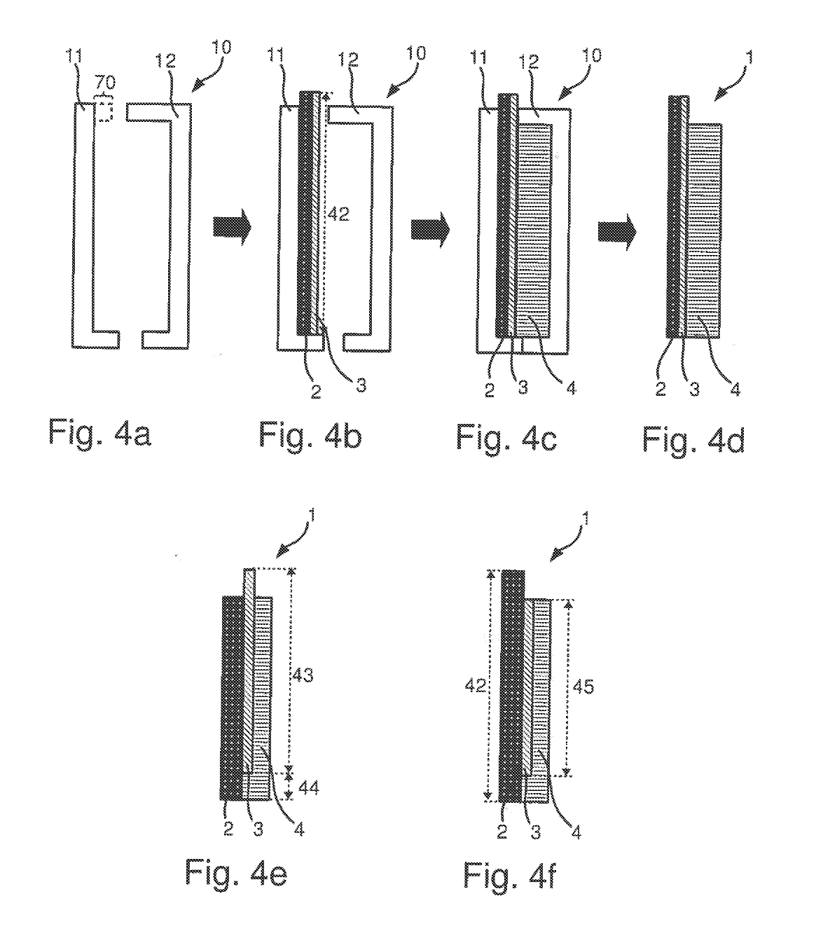

FIG. 4a to FIG. 4d show schematically method steps for producing a composite article

FIG. 4e and FIG. 4f show schematic sectional representations of design variants of a composite article

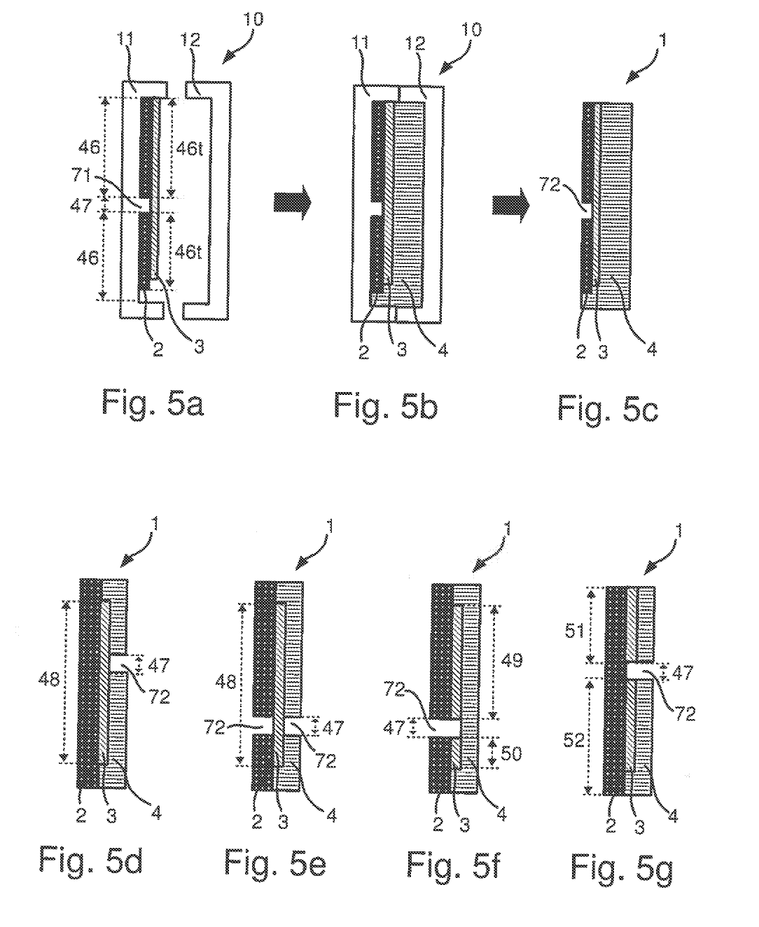

FIG. 5a to FIG. 5c show schematically method steps for producing a composite article

FIG. 5d to FIG. 5g show schematic sectional representations of design variants of a composite article

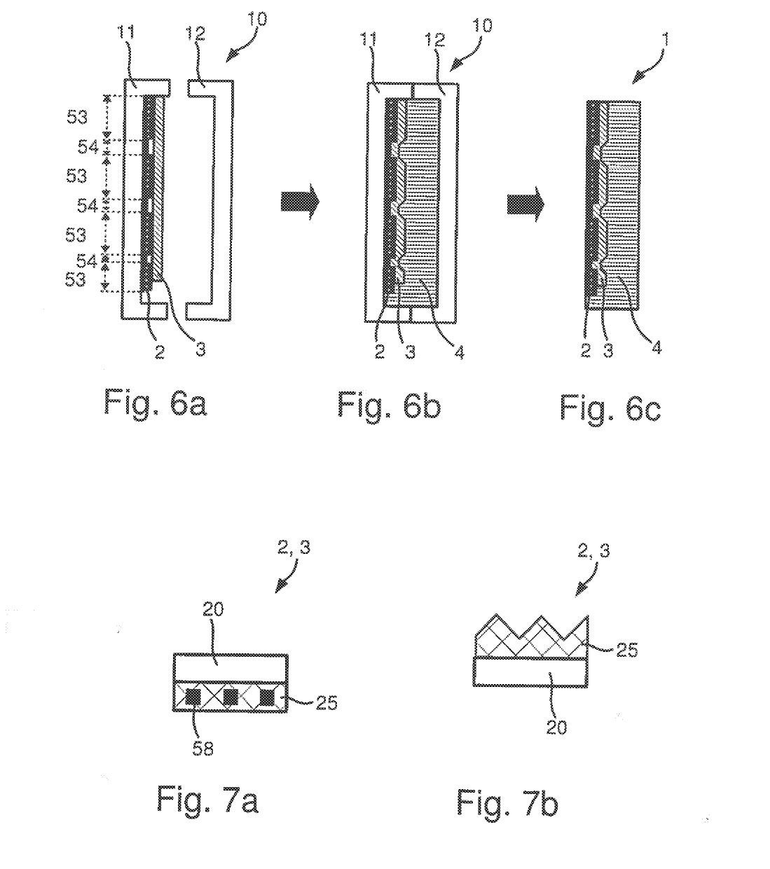

FIG. 6a to FIG. 6c show schematically method steps for producing a composite article

FIG. 7a and FIG. 7b show schematic sectional representations of insertion elements

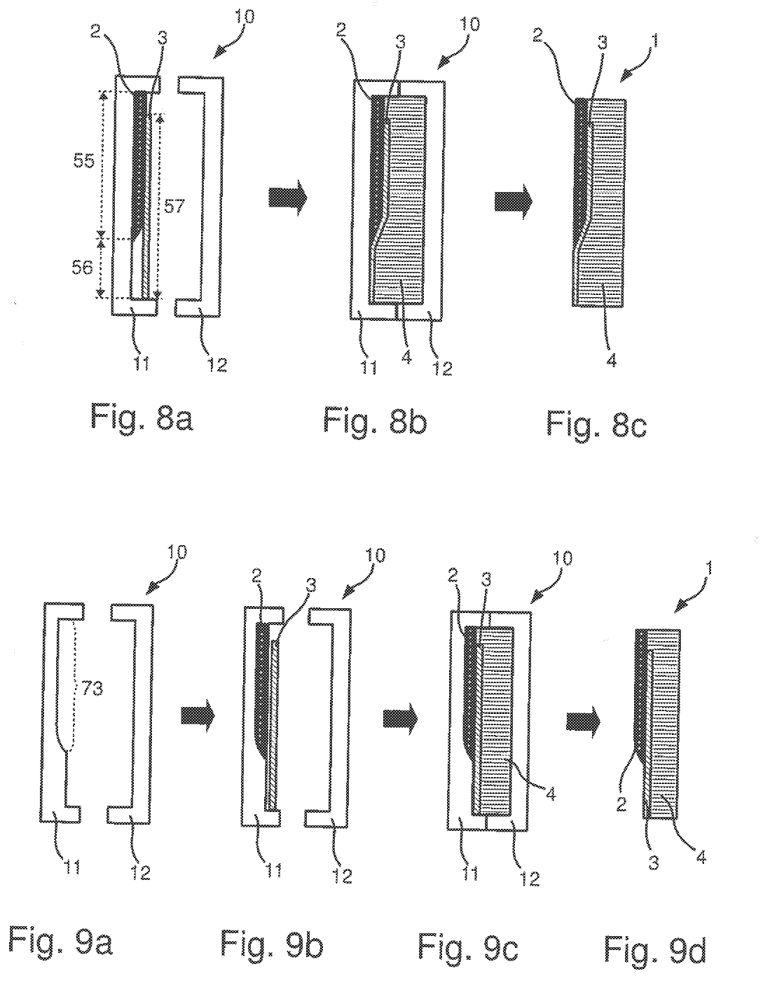

FIG. 8a to FIG. 8c show schematically method steps for producing a composite article

FIG. 9a to FIG. 9d show schematically method steps for producing a composite article

FIG. 1a to FIG. 1e show a method for producing a composite article 1. For this purpose, as shown in FIG. 1a, a tool mold 10 is provided which comprises tool molding parts 11, 12. The tool mold 10 further comprises a filling channel in at least one of the tool molding parts 11, 12. As shown in FIG. 1b, an insertion element 2 is arranged in the area 30 on the internal wall of the tool molding part 11. Here, the area 31 does not comprise the insertion element 2. The insertion element 2 is thus arranged in some areas on the internal wall of the tool molding part 11.

It is possible, for example, to position the insertion element 2 registered in the area 30 by means of a vacuum, with the result that the insertion element 2 is arranged registered according to the later functionality of the composite article 1. Furthermore, the insertion element 2 can be positioned registered by means of a clamping system, an advancing system, a pressure-sensitive adhesive and/or by means of electrostatic or physical adhesion, for example. It is also possible for the tool molding parts 11, 12 to comprise lugs, pins or recesses which enable a registered positioning of the insertion element 2. The insertion element 2 preferably has a thickness of at least 4 μm, preferably between 36 μm and 1 mm.

As shown in FIG. 1c, an insertion element 3 is arranged in the area 32 on the side of the insertion element 2 which faces away from the inner wall of the tool molding part 11. The area 33 does not comprise the insertion element 3.

The insertion element 3 can be arranged accurately fitting the insertion element 2, for example by means of a vacuum, as long as it forms at least one projection with respect to the latter through its width and/or length or is pre-positioned in the tool molding part 12. Furthermore, the insertion element 3 can be arranged accurately fitting the insertion element 2 by means of a clamping system, an advancing system, a pressure sensitive adhesive and/or by means of electrostatic or physical adhesion, for example. The insertion element 3 preferably has a thickness of at least 4 μm, preferably between 36 μm and 1 mm.

As shown in FIG. 1d, after the closure of the tool mold 10 by merging the tool molding part 11 and the tool molding part 12, the filling medium 4 is filled through the filling channel and the tool mold 10 is filled with it. The insertion element 3 is pressed against the insertion element 2. The insertion elements 2, 3 are thus backfilled with the filling medium 4 introduced via the filling channel. The insertion elements 2, 3 are hereby fixedly connected at least in some areas.

Depending on the material used for the insertion elements 2, 3, the parameters time, pressure and temperature can be adapted such that the insertion elements 2, 3 fixedly connect at least in some areas. Thus, for example, the parameter time during filling of the filling medium 4 in the case of predetermined parameters pressure and temperature during filling of the filling medium 4 can be chosen such that the insertion elements 2, 3 connect at least in some areas.

The filling of the filling medium 4 preferably takes place at a temperature in the range between 200° C. and 320° C., preferably between 240° C. and 290° C., further preferably between 240° C. and 270° C. It has proved useful if the filling of the filling medium 4 takes place at a pressure in the range between 10 bar and 2000 bar, preferably between 200 bar and 1500 bar, further preferably between 500 bar and 1300 bar.

The temperature of the tool mold 4 here is between 30° C. and 120° C., preferably between 40° C. and 100° C., further preferably between 60° C. and 80° C.

Furthermore, the filling medium 4 connects fixedly to the insertion element 2 and the insertion element 3. It is also possible for the filling medium 4 to connect fixedly to the insertion element 3 but not to the insertion element 2. The insertion element 2 is thus fixedly connected to the composite article 1 via the insertion element 3. It is also possible that filling medium 4 connects fixedly to the insertion element 2 but not to the insertion element 3, that insertion element 3 here is fixedly connected to the composite article 1 via the insertion element 2.

In planar areas, the thickness of the filling medium 4 is preferably between 0.1 mm and 5 mm, further preferably between 0.5 mm and 2 mm. In areas with partial reinforcement, such as e.g. supporting ribs or attachment points, the thickness of the filling medium can be 4 mm up to 25 mm, preferably up to 15 mm.

Here, the insertion elements 2, 3 can consist of different materials. Furthermore, the insertion elements 2, 3 can be constructed in one layer or comprise several layers. Here, the layers of the insertion element 2, 3 can consist of different materials. Typical materials of the insertion elements 2, 3 here are: PET, PP, ABS, PC, PVC, PEN, polyamide, TPE, PUR, EP resins, PF resins and UP resins. Furthermore, it is possible for the insertion elements to represent prefabricated semifinished parts made of the above-named plastics or solid materials such as metal or ceramic.

The filling medium 4 is preferably a polymeric material, for example PP, PC, ABS, PBT, PMMA, PS, PVC, TPU, polyamide or polyolefin, or also thermosetting reaction resin systems, such as for example PUR, EP resins, PF resins or UP resins. A likewise preferred variant is a filling medium 4 made of the educts of these materials and the initiators or additives optionally required for the polymerization during the method. Within the meaning of a functional integration, the filling medium 4 can be blends or mixtures of different types of material, and/or the filling medium 4 can already be enriched with reinforcing agents, such as for example glass, carbon or natural fibers, and/or fillers, such as for example copper, aluminum oxide or graphite, and/or additives, such as for example for coloring, foam formation or the formation of electrical conductivity paths.

It has proved useful if the following material pairs are used for the insertion elements 2, 3 or the layer adjacent to the filling medium 4 in the case of multilayer insertion elements 2, 3 and the filling medium 4: PP and PP, ABS and ABS/PC, PC and PC, PC and ABS/PC, ABS and PBT or ABS and PMMA, wherein the the first named material corresponds to the material of the insertion elements 2, 3 or the layer adjacent to the filling medium 4 in the case of multilayer insertion elements 2, 3 and the material and/or material mixture named in second place corresponds to the material of the filling medium 4.

It has furthermore proved useful, when using adhesion promoters suitable for the method, to use the following material pairs for the insertion elements 2, 3 or the layer adjacent to the filling medium 4 in the case of multilayer insertion elements 2, 3 and the filling medium 4: PET and PC, PET and ABS/PC, PET and PBT, PET and PA, PET and TPE, PET and TPU, PEN and PC, PEN and ABS/PC, PEN and PBT, PEN and PA, PEN and TPE, PEN and TPU, wherein the the first named material corresponds to the material of the insertion elements 2, 3 or the layer adjacent to the filling medium 4 in the case of multilayer insertion elements 2, 3 and the material and/or material mixture named in second place corresponds to the material of the filling medium 4.

After curing of the filling medium 4 to form a main body made of a the filling medium 4, or after cooling of the filling medium 4, the tool mold 10 is opened and the composite article 1 is removed, as shown in FIG. 1e. The cured main body including the insertion elements 2, 3 arranged thereon, wherein the insertion elements 2, 3 are fixedly connected at least in some areas, provide the composite article 1. As described above, the main body and the insertion element 2 and/or the insertion element 3 are fixedly connected at least in some areas.

FIG. 2a to FIG. 2k show schematic sectional representations of insertion elements 2, 3.

Thus, FIG. 2a shows an insertion element 2, 3 which consists of a carrier layer 20. If, for example, the insertion element 3 in FIG. 1d consists of the carrier layer 20, the carrier layer 20 is chosen such that it connects fixedly to the insertion element 2 during filling of the filling medium 4. Furthermore, the carrier layer 20 connects to the filling medium 4. Furthermore, it is possible for the carrier layer 20 to be dyed. The carrier layer 20 can also have a surface profile which is molded into the carrier layer 20 by means of an embossing tool. Furthermore, the carrier layer 20 can have a surface structure which is introduced into the carrier layer 20 subtractively by means of scratching or additively through applied structured varnish. It has proved useful if the carrier layer 20 is, for example, a polyester film. Furthermore, the carrier layer 20 can be made of ABS, PEN, PC or PMMA. The carrier layer preferably has a thickness between 4 μm and 75 μm, further preferably between 15 μm and 25 μm.

FIG. 2b shows an insertion element 2, 3 which comprises a carrier layer 20 and an adhesive layer 21. With respect to the carrier layer 20, reference is made here to the above statements. The adhesive layer 21 is a first coat which enables a fixed connection between the insertion elements 2, 3 and/or the insertion elements 2, 3 and the filling medium 4. The adhesive layer has, for example, a thickness in the range of from 0.4 μm to 5 μm. The adhesive layer 21 in FIG. 2b is present on one side of the carrier layer 20 and thus improves the fixed connection of the insertion elements 2, 3 or of the filling medium 4.

FIG. 2c shows an insertion element 2, 3 which has a carrier layer 20, an adhesive layer 21 and an adhesive layer 22. The adhesive layers 21, 22 here are arranged on both sides of the carrier layer 20 with the result that the fixed connection of the insertion elements 2, 3 and of the filling medium 4 is enabled. With respect to the design of the carrier layer 20 and of the adhesive layers 21, 22, reference is made here to the above statements.

FIG. 2d shows an insertion element 2, 3 which has a carrier layer 20 and a layer 23. With respect to the carrier layer 20, reference is made here to the above statements. The layer 23 can be a functional or decorative layer. The layer 23 can be applied to the carrier layer 20 over the whole surface or in some areas. If the layer 23 is realized as a functional layer 23, this is preferably formed from one or more of the following layers: a layer containing register marks, a layer containing a marking that can be detected haptically or by tactile means, an electrical functional layer, for example electrically conductive or semiconductive layer. The electrically conductive layer can comprise electrical conductive tracks made of metal and/or conductive polymers, electronic components, optoelectronic components or photosensitive or photoactive components, for example. Furthermore, the functional layer 23 can comprise, for example, an electrical oscillating circuit, an antenna, a sensor element or sensor field, for example a capacitive or resistive touch sensor field, an electrical display device or an electrical circuit with conductive tracks or electrical components. Furthermore, the functional layer 23 can comprise optical components, such as for example LEDs, OLEDs or optical waveguides. The functional layer 23 preferably has a layer thickness between 0.02 μm and 2 mm, further preferably between 3 μm and 1 mm.

Furthermore, the layer 23 can be a decorative layer 23. The decorative layer 23 can comprise decorative layers, such as e.g. opaque, translucent or transparent colored varnish layers, replication varnish layers or metal layers. The decorative layers can be molded for example over the whole surface or patterned, for example in the shape of alphanumeric characters or motifs. Furthermore, the decorative layer 23 can comprise optically variable layers with pigments, holograms, optical diffraction structures, lenses, prisms, thin film layers or crosslinked liquid crystals. Thus, the decorative layer 23 can comprise at least one layer with a decorative effect and/or a forgery-proofing function. Furthermore, it is possible for the decorative layer 23 to comprise a protective layer. A protective layer can be a transparent or translucent or opaque varnish layer with or without coloration, which is preferably very resistant to external mechanical and/or chemical influences. It has proved useful if the decorative layer 23 has a thickness of more than 0.02 μm, preferably has a thickness between 0.2 μm and 10 μm, further preferably between 0.25 μm and 5 μm.

FIG. 2e shows an insertion element 2, 3 which has a carrier layer 20, a functional or decorative layer 23 and the adhesive layer 21. The adhesive layer 21 is applied to the functional or decorative layer 23. Depending on the arrangement of the insertion element 2, 3, the adhesive layer 21 thus improves the fixed connection of the insertion elements 2, 3 or of the insertion element 2, 3 to the filling medium 4. With respect to the layers 20, 21 and 23, reference is made here to the above statements.

FIG. 2f corresponds to FIG. 2e with the difference that the adhesive layer 22 is applied to the carrier layer 20. With respect to the layers 20, 22 and 23, reference is made here to the above statements.

FIG. 2g corresponds to FIG. 2c with the difference that the insertion element 2, 3 has a functional or decorative layer 23. With respect to the layers 20, 21, 22 and 23, reference is made here to the above statements.

FIG. 2h corresponds to FIG. 2d with the difference that the insertion element 2, 3 has, in addition to the functional or decorative layer 23, the functional or decorative layer 24. The layer 24 can be applied to the carrier layer 20 over the whole surface or in some areas. With respect to the layers 20, 23 and 24, reference is made here to the above statements. It is thus possible for the layers 23, 24 to be two decorative layers. Thus, for example, the insertion element 2, 3 can produce a Moire effect for an observer if the carrier layer 20 is formed transparent and the decorative layers 23, 24 have a linear pattern, for example. Furthermore, it is also possible for the layers 23, 24 to be functional layers which are separated by the carrier layer 20. Thus, for example, electrical components of the layers 23, 24 can be capacitively coupled to each other. It is also possible for one of the layers 23, 24 to be a decorative layer and one of the layers 23, 24 to be a functional layer. Thus, for example, the layer 24 as decorative layer can mask electrical components of the layer 23 as functional layer for an observer, depending on the side of the insertion element 2, 3 observed.

FIG. 2i corresponds to FIG. 2h with the difference that the insertion element 2, 3 has an adhesive layer 21. With respect to the layers 20, 21, 23 and 24, reference is made here to the above statements.

FIG. 2j corresponds to FIG. 2i with the difference that the insertion element 2, 3 has the further adhesive layer 22. With respect to the layers 20, 21, 22, 23 and 24, reference is made here to the above statements.

FIG. 2k corresponds to FIG. 2f with the difference that the adhesive layer 22 is applied in the area 34. Through application of the adhesive layer 22 in some areas it can be achieved that the insertion element 2, 3 only makes a fixed connection in the area 34 or that the insertion element 2, 3 only makes a fixed connection to the filling medium 4 in the area 34. The area that is not fixedly connected can hereby be detached, for example, and enables access to the layer 20 in FIG. 2k.

Furthermore, it is possible to form the layers 20, 21, 22, 23 or 24 of the insertion elements 2, 3 over the whole surface or in some areas.

FIG. 3a to FIG. 3c show a method for producing a composite article 1. The method shown in FIG. 3a to FIG. 3c corresponds to the method shown in FIG. 1a to FIG. 1e with the difference that the insertion elements 2, 3 in FIG. 3a are arranged at the same time on the inner wall of the tool molding part 11. Thus, the insertion elements 2, 3 already adhere to each other and are thus arranged together on the inner wall of the tool molding part 11. The insertion elements 2, 3 can adhere to each other, for example, by means of a pressure-sensitive adhesive and/or by means of electrostatic or physical adhesion. Here, the adhesion is such that the insertion elements 2, 3 can be arranged together on the inner wall of the tool molding part 11, but they only obtain their final adhesion to each other through the further method. Furthermore, the insertion elements 2, 3 in FIG. 3a are arranged such that they cover the inner wall 11 of the tool molding part 11 over the whole surface. With respect to the further method steps and the design of the insertion elements 2, 3, reference is made here to the above statements.

FIG. 3d to FIG. 3g show schematic sectional representations of design variants of a composite article 1. Thus, FIG. 3d shows a composite article 1 which comprises the insertion elements 2, 3 in the area 35 and does not comprise the insertion elements 2, 3 in the area 36. During the production of the composite article 1, the filling medium 4 has flowed completely around the insertion elements 2, 3 and the insertion element 3 is encapsulated by the filling medium 4 and the insertion element 2. The composite article 1 in FIG. 3e comprises the insertion element 2 formed over the whole surface and, in the area 37, the insertion element 3. Here, the insertion element 2 can thus be reached from several sides of the composite article 1. FIG. 3f shows a composite article 1 which comprises the insertion element 2 in the area 38 and the insertion element 3 in the area 37. In the sectional representation, the area 38 hereby covers the area 37. Furthermore, FIG. 3g shows a composite article 1 which comprises the insertion element 3 in the area 40 and does not comprise the insertion element 3 in the area 41. Here, the insertion element 2 is formed over the whole surface. The filling medium 4 of the main body here has a larger contact surface with the insertion element 2. If, for example, the filling medium 4 is formed transparent and the insertion element 3 is formed opaque, in the areas 41 light can pass through the filling medium to the insertion element 2.

FIG. 4a to FIG. 4d show a method for producing a composite article 1. The method shown in FIG. 4a to FIG. 4d corresponds to the method shown in FIG. 3a to FIG. 3c and FIG. 1a to FIG. 1e with the difference that the tool molding part 11 has a cavity outlet 70 and the insertion elements 2, 3 in the area 42 are arranged such that the cavity outlet 70 is sealed by the insertion elements 2, 3 and the tool pressure after merging of the tool molding part 11 and the tool molding part 12. The insertion elements 2, 3 can, for example, be arranged registered by means of a clamping system before the filling of the filling medium 4. Depending on the number, shape and position of the cavity outlet 70, the insertion elements 2, 3 can, for example, be guided out of the composite article 1. Thus, FIG. 4e shows a composite article 1 in which the insertion element 3 is guided out of the composite article 1. If the insertion element 3 comprises electrical conductive tracks, as described above for example, these can thus be contacted via the outlet, for example. Furthermore, the insertion element 3 of the composite article 1 is present in the area 43 and not present in the area 44. FIG. 4f shows a composite article 1 in which the insertion element 2 is guided out of the composite article 1. The insertion element 2 of the composite article 1 is present in the area 42 and the insertion element 3 is present in the area 45. The outlets of the insertion elements 2, 3 in FIG. 4e and FIG. 4f can hereby be produced in one or both of the tool molding parts 11, 12, as described above, by means of a correspondingly molded cavity outlet 70. In FIG. 4e, the cavity outlet 70 is sealed by the insertion element 3 during filling of the filling medium 4 and in FIG. 4f the cavity outlet 70 is sealed by the insertion element 2 during filling of the filling medium 4. This sealing is effected in particular by mechanical loading of the sealing insertion elements 2, 3 by the adjacent tool molding parts 11, 12 lying or pressing on them.

FIG. 5a to FIG. 5c show a method for producing a composite article 1. The method shown in FIG. 5a to FIG. 5c corresponds to the method shown in FIG. 3a to FIG. 3c and FIG. 1a to FIG. 1e with the difference that the tool molding part 11 has an elevation 71 in the area 47 and does not have an elevation in the areas 46. As shown in FIG. 5a, the insertion element 2 is arranged in the areas 46t, in which the tool molding part 11 has no elevations 71. As shown in FIG. 5a, the area 46t, in which the insertion element 2 is arranged, is a partial area of the area 46, in which the tool molding part 11 has no elevation. As shown in FIG. 5a, the insertion element 3 covers the elevation 71 and is thus arranged in a partial area of the area 46 and in the area 47. The elevations 71 can also be formed as pins or studs. With respect to the further method steps and the design of the insertion elements 2, 3, reference is also made here to the above statements. As shown in FIG. 5c, a composite article 1 can hereby be produced which has a spatial recess 72, in which the insertion element 2 is not present and via which the insertion element 3 is directly accessible. Furthermore, it is possible for the elevation 71 to be designed patterned, for example in the shape of alphanumeric characters. Furthermore, it is possible for the tool molding part 11 to have several elevations 71. The elevations 71 can also vary in their height perpendicular to the plane spanned by the inner wall of the tool molding part 11 such that, depending on the height of the elevations 71, the insertion element 2 or the insertion element 2 and the insertion element 3 has recesses. In the case of multilayer insertion elements 2, 3, as described above, particular layers can also not be present in some areas. It is hereby possible, for example, for the tool molding part 11 to have elevations 71 in the areas in which, for example, the multilayer insertion element 2 does not comprise particular layers, whereby the multilayer insertion element 2 can be arranged registered by means of the elevations 71. By means of the elevations 71, recesses 72 can thus be produced in a targeted manner in the insertion elements 2, 3 of the composite article 1. Furthermore, the elevations 71 enable a precise positioning of the insertion elements 2, 3. Depending on the shape, size, design and positioning of the elevations 71, different composite articles 1 can be produced. Thus, for example, the surface of the composite article 1 can be designed by means of the shape and the number and the distance between the elevations 71. FIG. 5d shows a composite article 1 which has a recess 72 in the area 47 in the filling medium 4 of the main body. Furthermore, the composite article 1 comprises the insertion element 3 in the area 48. The insertion element 3 is thus accessible via the recess 72. The composite article 1 of FIG. 5e has a recess 72 in the area 47 in the filling medium 4 of the main body and a recess 72 in the area 47 of the insertion element 2. The insertion element 3, which is present in the area 48, is thus accessible from two sides of the composite article 1. The composite article 1 of FIG. 5f has a recess 72 in the area 47 of the insertion elements 2, 3 and the insertion element 3 is thus only present in areas 49 and 50. Furthermore, FIG. 5g shows a composite article 1 which has, in the area 47, a recess 72 in the filling medium 4 of the main body and in the insertion element 3. The filling medium 4 is thus present in the areas 51 and 52 and not present in the area 47.

FIG. 6a to FIG. 6c show a method for producing a composite article 1. The method shown in FIG. 6a to FIG. 6c corresponds to the method shown in FIG. 3a to FIG. 3c and FIG. 1a to FIG. 1e with the difference that the insertion element 2 has a structured surface profile. Furthermore, as shown in FIG. 6a, the insertion elements 2, 3 can be inserted at the same time.

As shown in FIG. 6a, the insertion element 2 comprises recessed areas 54 and raised areas 53. The insertion element 2 has a replication varnish layer, for example, in which a structured surface profile is stamped by means of an embossing tool, for example a replication roller or an embossing die. The structured surface profile has a structure depth between 2.5 μm and 1500 μm, preferably between 10 μm and 200 μm, further preferably between 15 μm and 65 μm. Here, the structure depth is the height distance between the raised areas 53 and the recessed areas 54, wherein the height distance is based on a direction perpendicular to the surface formed by the inner wall of the tool molding part 11. The replication varnish layer has a thickness between 2.5 μm and 1500 μm, preferably between 10 μm and 200 μm, further preferably between 15 μm and 65 μm. If the structure depth is chosen smaller than the thickness of the replication varnish layer, the base of the recessed areas 54 is covered by the replication varnish layer.

The replication varnish layer consists, for example, of a thermoplastic varnish into which the surface profile is molded by means of heat and pressure by the action of an embossing tool. Furthermore, it is also possible for the replication varnish layer to be formed by a UV-crosslinkable varnish and for the surface profile to be molded into the replication varnish layer by means of UV replication. The surface profile is molded into the uncured replication varnish layer by the action of an embossing tool and the replication varnish layer is cured by irradiation with UV light before and/or immediately during and/or after the molding.

Furthermore, it is possible that the replication varnish layer has a metalization at least in some areas, for example a thin metal layer made of gold, silver, chromium, copper or aluminum, in particular with a thickness between 0.5 nm and 50 nm.

As shown in FIG. 6a, an insertion element 3 is arranged on the side of the insertion element 2 which faces away from the inner wall of the tool molding part 11. With respect to the design of the insertion element 3, reference is made here to the above statements.

As shown in FIG. 6b, after the closure of the tool mold 10 by merging the tool molding part 11 and the tool molding part 12, the filling medium 4 is filled through the filling channel and the tool mold 10 is thus filled with it. The insertion element 3 is pressed against the insertion element 2 such that the insertion element 3 is pressed into the recessed areas 54 of the insertion element 2 until the insertion element 3 has contact with the insertion element 2 in all areas. The insertion elements 2, 3 are hereby fixedly connected at least in some areas. With respect to the filling of the filling medium 4, reference is made here to the above statements. Furthermore, the filling medium 4 connects fixedly to the insertion element 3 at least. As shown in FIG. 6b, the insertion element 2 likewise has a structured surface profile in dependence on the structured surface profile of the insertion element 2.

After curing of the filling medium 4 to form a main body or after cooling of the filling medium 4, the tool mold 10 is opened and the composite article 1 is removed, as shown in FIG. 6c. The cured main body including the insertion elements 2, 3 arranged thereon provides the composite article 1. In principle, the size ratios can also be the opposite of the ratios represented in the figures; this means that the part of the composite article made from the filling medium is smaller than the part of the insertion elements.

FIG. 7a and FIG. 7b show schematic sectional representations of insertion elements 2, 3.

Thus, FIG. 7a shows an insertion element 2, 3 which has a carrier layer 20 and a structural layer 25. With respect to the layer 20, reference is made here to the above statements. Here, the structural layer 25 comprises areas 58 which deform more or less than the rest of the structural layer 25 under pressure and heat. It is thus possible for the structural layer 25 to consist, for example, of a physically or chemically expanded material, wherein the areas 58 can be deformed more or less under pressure and heat. Thus, the areas 58 of the structural layer 25 can thus be formed from a material that substantially withstands or cannot be compressed by the parameters pressure and temperature during filling of the filling medium 4, with the result that the areas 58 act as spacers between the rigid inner wall of the tool molding part 11 and the insertion element 3. The areas 58 thus experience no or only very slight deformation during filling of the filling medium 4. Furthermore, the structural layer 25 can be applied only in some areas. The structural layer 25 preferably has a thickness between 2.5 μm and 1500 μm, preferably between 10 μm and 200 μm, further preferably between 15 μm and 65 μm.

FIG. 7b shows an insertion element 2, 3 which has a carrier layer 20 and a structural layer 25. With respect to the carrier layer 20, reference is made here to the above statements. Here, the structural layer 25 is molded as a replication varnish layer and has a structured surface profile which is stamped, for example, by means of an embossing die. With respect to the replication varnish layer, reference is made here to the above statements.

Furthermore, it is possible to form the layer 25 of the insertion elements 2, 3 over the whole surface or in some areas.

FIG. 8a to FIG. 8c show method steps for producing a composite article 1.

As shown in FIG. 8a, an insertion element 2 is arranged in the area 55 on the inner wall of the tool molding part 11. As shown in FIG. 8a, the insertion element 2 is not arranged in the area 56. Furthermore, the insertion element 3 is arranged in the area 57 on the side of the insertion element 2 which faces away from the inner wall of the tool molding part 11. Here, the area 57 covers the area 56, in which the insertion element 2 is not arranged. Furthermore, the area 57 at least partially covers the area 55, in which the insertion element 2 is arranged.

As shown in FIG. 8b, after the closure of the tool mold 10 by merging the tool molding part 11 and the tool molding part 12, the filling medium 4 is filled through the filling channel and the tool mold 10 is thus filled with it. The insertion element 3 is pressed against the insertion element 2 and against the inner wall of the tool molding part 11. As shown in FIG. 8b, the insertion element 3 adapts itself to the contour of the insertion element 2. The insertion elements 2, 3 are hereby fixedly connected at least in some areas. With respect to the filling of the filling medium 4, reference is made here to the above statements. Furthermore, the filling medium 4 connects fixedly to the insertion element 3 at least.

After curing of the filling medium 4 to form a main body made of a filling medium 4, or after cooling of the filling medium 4, the tool mold 10 is opened and the composite article 1 is removed, as shown in FIG. 8c. The cured main body including the insertion elements 2, 3 arranged thereon provides the composite article 1 and has a planar surface.

FIG. 9a to FIG. 9d show method steps for producing a composite article 1.

For this purpose, as shown in FIG. 9a, a tool mold 10 is provided which comprises the tool molding parts 11, 12. The tool mold 10 further comprises a filling channel in at least one of the tool molding parts 11, 12. The tool molding part 11 further comprises a shaped recess 73.

As shown in FIG. 9b, an insertion element 2 is arranged in the shaped recess 73 of the tool molding part 11, on the inner wall thereof. Furthermore, the insertion element 3 is arranged on the side of the insertion element 2 which faces away from the inner wall of the tool molding part 11.

As shown in FIG. 9c, after the closure of the tool mold 10 by merging the tool molding part 11 and the tool molding part 12, the filling medium 4 is filled through the filling channel and the tool mold 10 is thus filled with it. The insertion element 3 is pressed against the insertion element 2. The insertion elements 2, 3 are thus backfilled with the filling medium 4 introduced via the filling channel. The insertion elements 2, 3 are hereby fixedly connected at least in some areas. With respect to the filling of the filling medium 4, reference is made here to the above statements. Furthermore, the filling medium 4 connects fixedly to the insertion element 3 at least in some areas.

After curing of the filling medium 4 to form a main body made of a filling medium 4, or after cooling of the filling medium 4, the tool mold 10 is opened and the composite article 1 is removed, as shown in FIG. 9d. The cured main body including the insertion elements 2, 3 arranged thereon provides the composite article 1 and has a non-planar surface, as shown in FIG. 9d.

Furthermore, it is possible in the embodiment examples shown above for three or more insertion elements to be arranged and to be fixedly connected during filling of the filling medium 4. The three or more insertion element can be fixedly connected both to each other and fixedly connected to the filling medium 4. Furthermore, the embodiment examples shown above can be combined with each other such that it is possible, for example, that a tool molding part 11 has a cavity outlet 70 and a shaped recess 73. A composite article 1 can hereby be produced which has a non-planar surface and outlets of insertion elements 2, 3, as described above.

### LIST OF REFERENCE NUMBERS

1 composite article

2, 3 insertion element

4 filling medium

10 tool mold

11, 12 tool molding part

20 carrier layer

21, 22 adhesive layer

23, 24 functional layer/decorative layer

25 structural layer

30, 31, 32, 33, 34, 35, 36,

37, 38, 40, 41, 42, 43, 44,

45, 46, 46t, 47, 48, 49,

50, 51, 52, 53, 54, 55, 56,

57, 58 areas

70 cavity outlet

71 elevation

72 recess

73 shaped recess

1. A method for producing a composite article, comprising:
a) providing a tool mold, which comprises a first tool molding part and a second tool molding part, wherein the first tool molding part and/or the second tool molding part has a filling channel;
b) arranging at least two insertion elements in such a way that at least one first insertion element of the at least two insertion elements bears at least in some areas against the inner wall of the first tool molding part or against the inner wall of the second tool molding part, and that at least one second insertion element of the at least two insertion elements is arranged at least in some areas on the side of the at least one first insertion element which faces away from the inner wall of the first tool molding part or the side of the at least one first insertion element which faces away from the inner wall of the second tool molding part;
c) closing the tool mold by merging the first tool molding part and the second tool molding part; and
d) filling a filling medium through the filling channel in such a way that the at least one second insertion element of the at least two insertion elements is pressed against the at least one first insertion element of the at least two insertion elements and that the at least one first insertion element of the at least two insertion elements and the at least one second insertion element of the at least two insertion elements are fixedly connected at least in some areas.

2. The method according to claim 1, wherein, in step d), the at least one first insertion element of the at least two insertion elements and/or the at least one second insertion element of the at least two insertion elements are fixedly connected at least in some areas to the filling medium.

3. The method according to claim 1, wherein, in step b), the at least one first insertion element of the at least two insertion elements and the at least one second insertion element of the at least two insertion elements are arranged accurately fitting each other.

4. The method according to claim 1, wherein, in step a), a tool mold is provided with at least one cavity outlet in the first tool molding part and/or in the second tool molding part and, in step b), the at least one first insertion element of the at least two insertion elements and/or the at least one second insertion element of the at least two insertion elements is arranged such that the at least one cavity outlet is sealed, after merging of the first tool molding part and the second tool molding part, by the at least one first insertion element of the at least two insertion elements and/or the at least one second insertion element of the at least two insertion elements.

5. The method according to claim 1, wherein, in step a), a tool mold is provided with at least one shaped recess in the first tool molding part and/or in the second tool molding part and, in step b), the at least one first insertion element of the at least two insertion elements is inserted in the at least one shaped recess such that the at least one first insertion element of the at least two insertion elements forms a planar surface with the internal wall of the first tool molding part and/or the internal wall of the second tool molding part.

6. The method according to claim 1, wherein, the at least one first insertion element of the at least two insertion elements arranged in step b) has a structural layer and/or a structured surface profile and wherein, in step d), the filling medium is filled in such a way that the structural layer and/or the structured surface profile stamps a relief on the at least one second insertion element of the at least two insertion elements.

7. The method according to claim 1, wherein, in step b), the at least one first insertion element of the at least two insertion elements is arranged such that the at least one first insertion element of the at least two insertion elements occupies the internal wall of the first tool molding part and/or the internal wall of the second tool molding part in a first area and does not occupy it in a second area, and wherein the at least one second insertion element of the at least two insertion elements occupies at least the second area.

8. The method according to claim 7, wherein the at least one second insertion element of the at least two insertion elements is arranged on the side of the at least one first insertion element which faces away from the internal wall of the first tool molding part and/or the side of the at least one first insertion element which faces away from the internal wall of the second tool molding part such that the at least one first insertion element of the at least two insertion elements is covered at least in some areas in the first area by the at least one second insertion element of the at least two insertion elements.

9. The method according to claim 1, wherein, in step d), the filling of the filling medium takes place at a temperature in the range between 200° C. and 320° C., and/or wherein, in step d), the filling of the filling medium takes place at a temperature of the tool mold in the range between 30° C. and 120° C.

10. The method according to claim 1, wherein, in step d), the filling of the filling medium takes place at a pressure in the range between 10 bar and 2000 bar.

11. The method according to claim 1, wherein, in step b), the at least one first insertion element of the at least two insertion elements is arranged with at least one adhesive layer (21, 22) and/or the at least one second insertion element of the at least two insertion elements is arranged with at least one adhesive layer, wherein the parameters pressure and temperature in step d) during filling of the filling medium are chosen such that the at least one adhesive layer is fixedly connected at least in some areas to the at least one second insertion element of the at least two insertion elements and/or to the at least one first insertion element of the at least two insertion elements.

12. The method according to claim 11, wherein in step b), the at least one second insertion element of the at least two insertion elements is provided with a first adhesive layer on the side of the at least one second insertion element of the at least two insertion elements which faces the inner wall of the first tool molding part or the side of the at least one second insertion element of the at least two insertion elements which faces the inner wall of the second tool molding part and wherein the at least one second insertion element of the at least two insertion elements is provided with a second adhesive layer on the side of the at least one second insertion element of the at least two insertion elements which faces away from the inner wall of the first tool molding part or the side of the at least one second insertion element of the at least two insertion elements which faces away from the inner wall of the second tool molding part, wherein the parameters pressure and temperature in step d) during filling of the filling medium are chosen such that the first adhesive layer and the at least one first insertion element of the at least two insertion elements are fixedly connected at least in some areas and the second adhesive layer are fixedly connected to the filling medium at least in some areas.

13. The method according to claim 1, wherein, in step b), the at least one first insertion element of the at least two insertion elements is arranged in one or more third areas and is not arranged in one or more fourth areas, wherein the internal wall of the first tool molding part and/or the internal wall of the second tool molding part of the tool mold provided in step a) has, in the one or more fourth areas, an elevation and, in the one or more third areas, does not have the elevation.

14. The method according to claim 1, further comprising the following steps, which are performed after step d):
e) curing the filling medium to form a main body; and
f) removing the cured main body including the at least two insertion elements arranged thereon, wherein the main body and the at least one first insertion element of the at least two insertion elements fixedly connected thereto at least in some areas and/or the at least one second insertion element of the at least two insertion elements, which is fixedly connected at least in some areas to the first insertion element of the at least two insertion elements, provide the composite article.

15. The method according to claim 14, wherein, in step e), during curing of the filling medium, in one or more fourth areas in the filling medium, one or more spatial recesses are formed, which correspond to the negative form of the elevation in the one or more fourth areas.

16. The method according to claim 14, wherein the composite article removed in step f), which comprises the cured main body including the at least two insertion elements arranged thereon, is post-tempered and/or wherein, after or during curing of the filling medium to form a main body, the composite article, which comprises the cured main body including the at least two insertion elements arranged thereon, is post-tempered in the tool mold in step e).

17. The method according to claim 1, wherein, in step b), three or more insertion elements are provided in such a way that at least one third insertion element of the three or more insertion elements is arranged at least in some areas on the side of the first insertion element of the at least two insertion elements which faces away from the inner wall of the first tool molding part or the side of the first insertion element of the at least two insertion elements which faces away from the inner wall of the second tool molding part.

18. The method according to claim 17, wherein, in step d), the at least one first insertion element of the at least two insertion elements and the at least one third insertion element of the three or more insertion elements are fixedly connected by the filling of the filling medium and/or the at least one second insertion element of the at least two insertion elements and the at least one third insertion element of the three or more insertion elements are fixedly connected by the filling of the filling medium.

19. The method according to claim 1, wherein the filling medium filled in step d) is supplemented or replaced by a preheated semifinished part.

20. The method according to claim 1, wherein one or more surfaces of one or more materials introduced into the composite article and/or the one or more of the at least two insertion elements are completely or partially preprocessed by thermal, physical or chemical surface treatment.

21. The method according to claim 1, wherein the optimum temperature progression for the method is supported by a variable tempering of the tool mold.

22. A composite article comprising a main body made of a filling medium and at least two insertion elements wherein at least one first insertion element of the at least two insertion elements and at least one second insertion element of the at least two insertion elements are arranged in such a way that the at least one second insertion element of the at least two insertion elements is arranged between the at least one first insertion element of the at least two insertion elements and the main body, and wherein the first insertion element of the at least two insertion elements and the second insertion element of the at least two insertion elements are fixedly connected at least in some areas.

23. The composite article according to claim 22, wherein the at least one first insertion element of the at least two insertion elements and/or the at least one second insertion element of the at least two insertion elements has a structural layer and/or a structured surface profile.

24. The composite article according to claim 22, wherein the at least one first insertion element of the at least two insertion elements and/or the at least one second insertion element of the at least two insertion elements comprises a carrier layer.

25. The composite article according to claim 24, wherein the carrier layer is a dyed carrier layer.

26. The composite article according to claim 24, wherein the carrier layer is a carrier layer enriched with reinforcing agents and/or fillers and/or additives.

27. The composite article according to claim 22, wherein the at least one first insertion element of the at least two insertion elements and/or the at least one second insertion element of the at least two insertion elements has at least one adhesive layer.

28. The composite article according to claim 27, wherein the at least one adhesive layer is arranged on the side of the at least one first insertion element of the at least two insertion elements which faces the second insertion element of the at least two insertion elements.

29. The composite article according to claim 27, wherein a first adhesive layer is arranged on the side of the at least one second insertion element of the at least two insertion elements which faces the first insertion element of the at least two insertion elements wherein a second adhesive layer is arranged on the side of the at least one second insertion element of the at least two insertion elements which faces the main body.

30. The composite article according to claim 22 wherein the at least one first insertion element of the at least two insertion elements and/or the at least one second insertion element of the at least two insertion elements has at least one functional layer.

31. The composite article according to claim 30, wherein the at least one functional layer is an optically active layer and/or has metalized conductive tracks.

32. The composite article according to claim 22, wherein the at least one first insertion element of the at least two insertion elements and/or the at least one second insertion element of the at least two insertion elements has at least one decorative layer.

33. The composite article according to claim 22, wherein the at least one first insertion element of the at least two insertion elements and/or the at least one second insertion element of the at least two insertion elements has at least one separation layer at least in some areas.
